(19) United States
(12) Patent Application Publication
(10) Pub. No.: US 2007/0041409 A1
(43) Pub. Date: Feb. 22, 2007

(54) Injection locked high power laser systems

(76) Inventors: Venkatapuram Sriraman Sudarshanam, Big Flats, NY (US); Luis Alberto Zenteno, Painted Post, NY (US); Dmitri Vladislavovich Kuksenkov, Painted Post, NY (US); Donnell Thaddeus Walton, Painted Post, NY (US); Ji Wang, Painted Post, NY (US)

Correspondence Address: CORNING INCORPORATED, SP-TI-3-1, CORNING, NY, 14831, US

(21) Appl. No.: 11/207,378

(22) Filed: Aug. 19, 2005

(51) Int. Cl. H01S 3/30; H01S 3/098

(52) U.S. Cl. 372/6; 372/18

(57) ABSTRACT

A high power laser system comprising: a master laser; and a primary slave laser oscillator including a cavity comprising a rare earth doped fiber, said primary slave laser oscillator being actively injection-locked to said master laser, wherein said cavity provides an output exceeding 1 W of optical power.

### BACKGROUND OF THE INVENTION

1. Field of the Invention

The present invention relates generally to high power laser systems which involve the active locking of a high power primary slave laser oscillator to a low power master laser, and particularly to high power rare earth doped double clad fiber hybrid primary slave laser oscillators.

2. Technical Background

Although high power laser systems comprising a low power master laser injection locked to a primary (slave) laser oscillator are known, such laser systems utilize solid state (i.e., solid laser crystal) gain media. The laser crystal is typically long, about 60 mm, and small in diameter, about 1.6 mm, and is cut at Brewster angle, which results in the crystal having a narrow optical aperture. Thermal lensing in the laser crystal and the narrow aperture of the laser crystal lead to the requirement that the laser cavity length is kept short, typically about 50 cm. The free spectral range of the cavity f_{cav} is therefore much larger (by about a factor of 10) than the modulation frequency, f_{mod}, of the electro-optic modulator required for injection-locking.

Such solid-state laser systems do not provide a diffraction-limited output, especially when scaled to operate at high powers. Further, optical birefringence induced at high powers (due to high thermal stresses) results in modal instabilities, and also in depolarization. In these types of laser systems the solid state (crystal) laser medium has a problem of thermal dissipation, where the crystal absorbs some of the pump light and loses it through heat, thus making the laser system less efficient and making the stable operation at high output powers difficult. Formation of thermal lens, aberrations and fracture of the crystal due to thermal stresses when operated at high powers are commonly known. These thermal effects result in instabilities (fluctuations) in both spectral and modal behavior of the laser system output.

The injection locked laser system described above can be utilized for generation of light at the second or higher order harmonic frequency, utilizing appropriately phase matched frequency converter crystals. For example, light at the deep ultraviolet (DUV) wavelength of 198 nm may be generated via the sum frequency generation (SFG) of light at the infrared (IR) wavelength of 1064 nm and the ultraviolet (UV) wavelength of 244 nm. However, in such a method of generating deep-ultraviolet light, one has to consider the optical damage to the frequency converter crystal. This damage arises mainly from the concurrent presence of both the IR and UV light. This limits the number of hours of operation of the frequency converter crystal before optical damage sets in, resulting in severe loss of conversion efficiency.

For example, one manufacturer of industrial lasers has disclosed a maximum of about 70 hours of operation for any given spot on the frequency converter crystal (CLBO), when 200 mW of DUV power at 198 nm was generated from 500 W of intracavity IR power at 1064 nm and 600 mW of UV power at 244 nm. In order to increase the total lifetime of the laser system, the frequency converter crystal had to be shifted laterally to another spot of operation after 70 hours of operation. Thus, about 100 indexed locations were required to increase the lifetime to beyond 5000 hours, before the frequency converter crystal had to be replaced completely. Similarly, another laser manufacturer has reported 3 hours of operation at the power level of 3 W at 266 nm, when a frequency converter crystal (CLBO) was utilized to generate light at the second harmonic wavelength (266 nm) from an intracavity power of 290 W at the fundamental wavelength of 532 nm.

### SUMMARY OF THE INVENTION

One aspect of the invention is a high power laser system comprising: a master laser; and a primary slave laser oscillator including cavity comprising a rare earth doped fiber, said primary slave laser oscillator being locked to the master laser, wherein said cavity provides an output exceeding 1 W of optical power. In some of the embodiments the output exceeds 50 W, and 100 W, and 150 W of optical power.

According to an embodiment of the present invention the optical path length within the earth doped fiber is longer than the passive optical path length within the primary laser oscillator.

According to an embodiment of the present invention the cavity includes a phase modulator that is capable of stretching at least a portion of said earth doped fiber to lock the optical signal frequency, and the phase modulator functions as a modal filter.

According to one embodiment of the present invention the rare earth doped fiber is a polarization maintaining fiber. According to another embodiment of the present invention the rare earth doped fiber is a single polarization fiber.

According to some embodiments the cavity includes a second harmonic generator.

The laser systems according to the present invention are capable of providing several advantages: high out put power, for example hundreds of Watts, high spectral purity of output and stability of operation, while also featuring the advantages of compactness, and high resistance to optical damage.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1a is a schematic of a laser system according to one embodiment of the present invention.

FIG. 1b illustrates schematically separation f_{mod} between the carier frequency A and the side bands B, and the modulation frequency f_{cav} of the primary laser oscillator cavity.

FIG. 2 is a schematic of the optical and electronic configuration for a laser system according to the embodiment of the present invention.

FIG. 3 is a schematic illustration of the laser system according to a third embodiment of the present invention.

FIG. 4 is a schematic illustration of the laser system according to the fourth embodiment of the present invention.

FIG. 5 is a schematic illustration of the laser system according to the fifth embodiment of the present invention.

FIG. 6 is a schematic illustration of the laser system according to the sixth embodiment of the present invention.

### DETAILED DESCRIPTION OF THE PREFERRED EMBODIMENTS

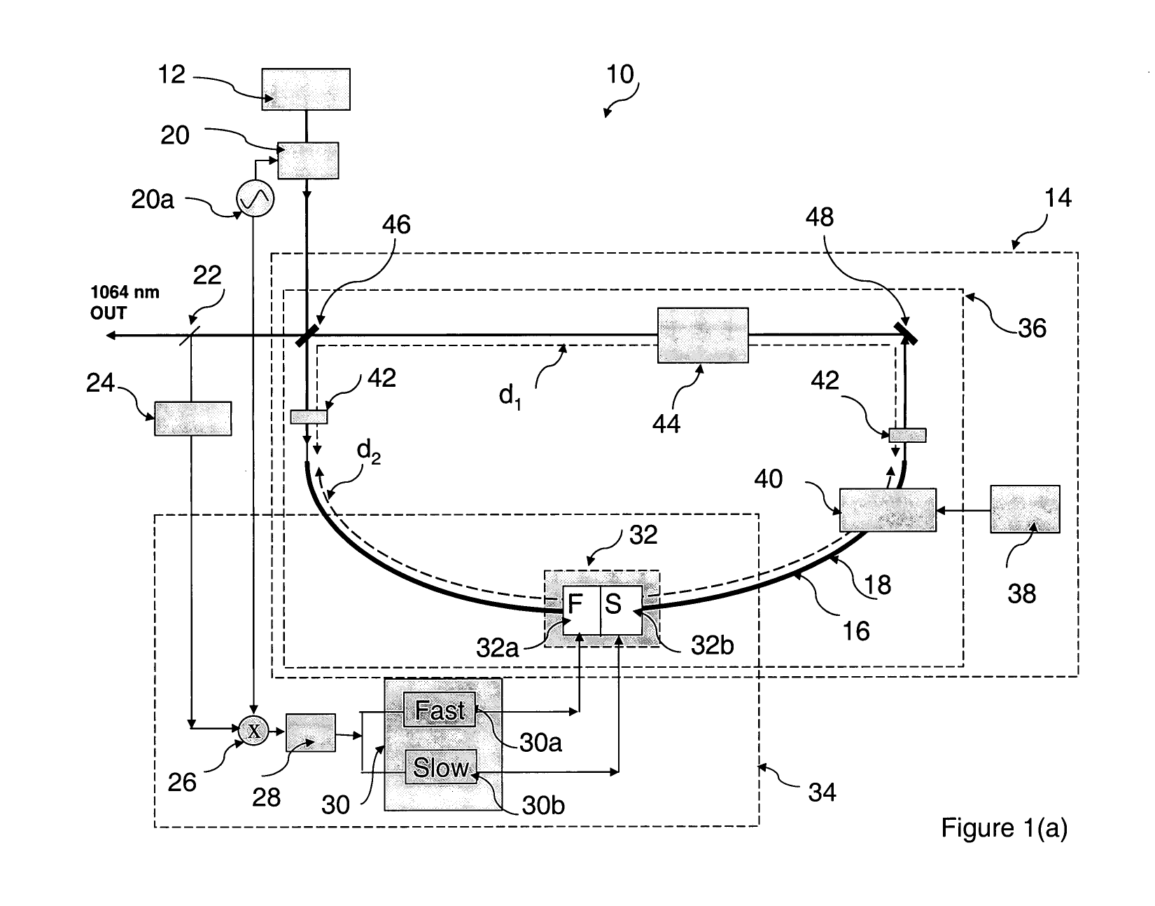

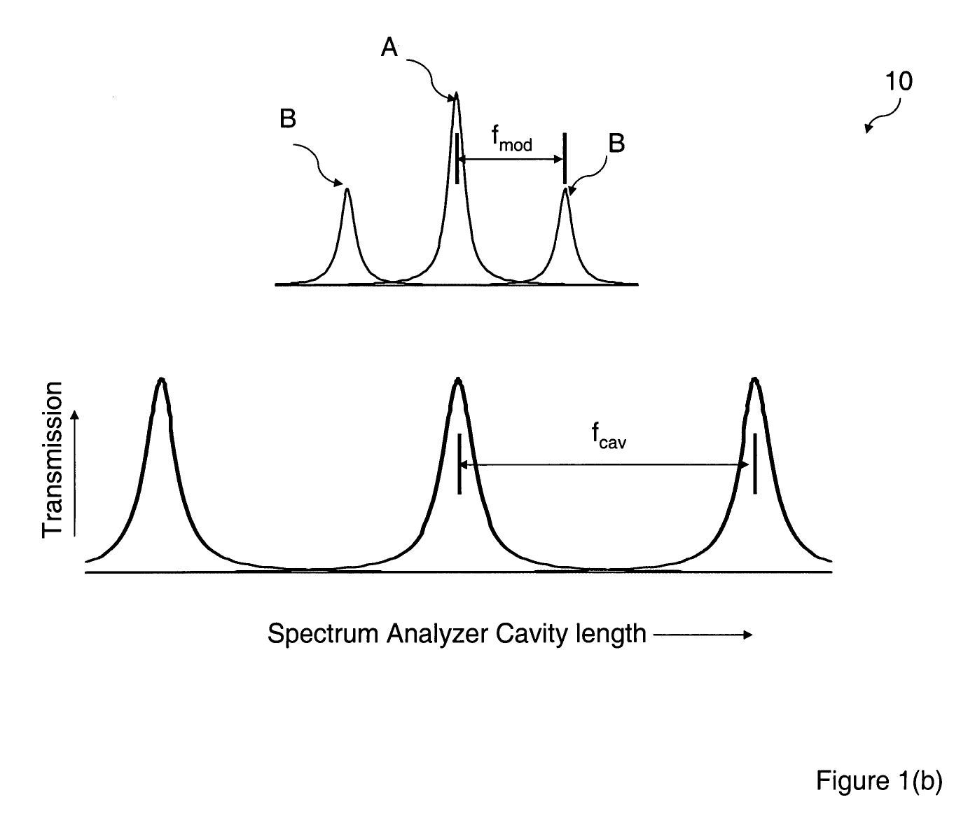

Referring now to FIG. 1a, illustrated therein is the optical and electronic schematic of an exemplary laser system 10 comprising a low power master laser 12 and a high power slave laser oscillator 14 (also referred to as a primary laser oscillator herein) which includes, as an active medium, a length of rare earth doped fiber 16. The term “oscillator” signifies that the high power slave laser oscillator 14 can independently generate on its own a coherent laser output without the input from the master laser 12, as would be the case when it is not injection-locked to the master laser 12. When active injection locking is not achieved, the spectral linewidth of the high power slave laser oscillator would be broad, for example, as much as 20 nm broad when an Yb doped fiber is utilized. When active injection locking is achieved, the spectral linewidth of the high power slave laser oscillator would become much narrower, for example, 10 pm broad. Thus active injection locking provides a high output power from the slave laser oscillator 14, while retaining the spectral characteristics of the master laser 12. In this embodiment the high power slave laser 14 includes Yb-doped double clad fiber (DCF) 18. In this and some of the exemplary embodiments the output of the laser 14 exceeds 50 W, and 100 W, and 150 W of optical power. For example, active injection locking may be achieved through a feedback circuit, which appropriately changes the optical path length within the cavity of the primary slave laser oscillator 14. In this embodiment, the laser 14 is actively injection locked to the single frequency master laser 12, utilizing the well known Pound-Drever-Hall (PDH) locking technique. When actively injection-locked, the wavelength of the slave laser 14 will be identical to the wavelength of the master laser 12. The indicated operation wavelength of 1064 nm for the injection-locked assembly of the master laser 12 and the slave laser 14 is only a representative example, and the master laser 12 and the slave laser 14 can be individually tuned over the whole range of Yb emission, namely 1020 nm to 1180 nm. The low power single-frequency output of the master laser 12 is transmitted through an electro-optic modulator (EOM) 20, driven by a driver 20a. The electro-optic modulator (EOM) 20 generates two side-bands B, each separated by the frequency difference, f_{mod}, from the carrier frequency A which corresponds to the optical frequency of the master laser 12, see FIG. 1b. The frequency difference f_{mod} between each side-band B and the carrier frequency A is equal to the (electrical) drive frequency of the electro optic modulator EOM 20. A partially reflecting mirror 22 directs a portion of the output light of the master laser 14 into the photodetector 24. The electrical output of the photodetector 24 is mixed with the reference electrical signal from the driver 20a utilizing a double-balanced mixer 26. The high frequency components in the output of the mixer 26 are filtered out by the electrical filter 28. The electrical signal at the output of the filter 28 is directed to an integrator assembly 30, comprising of a fast integrator 30a and slow integrator 30b. In this embodiment, the electrical output of the fast integrator 30a is directed to the fast response section 32a of an (optical) phase modulator 32. Similarly, the electrical output of the slow integrator 30b is directed to the slow response section 32b of the phase modulator 32. The mixer 26, the filter 28, the integrator assembly 30 and the phase modulator 32 together form the feedback unit 34. The phase modulator 32 may be generally constructed by coiling and bonding one section of the rare earth doped fiber 16 onto one piezoelectric cylinder (not shown), and preferably by coiling and bonding two sections of the rare earth doped fiber 16 to two separate piezoelectric cylinders 32a, 32b. The piezoelectric cylinder 32a is smaller in diameter than the piezoelectric cylinder 32b, and thus serves as a fast phase modulator (while the piezoelectric cylinder 32b with the larger diameter serves as a slow phase modulator). Alternatively, the piezoelectric cylinder 32a may be replaced by a clip-on set of two piezoelectric half-cylinders (not shown). The optical length (the product of the refractive index n and geometrical length d) of the optical fiber 16 is modulated (varied) by the electrical signals driving the two piezoelectric cylinders 32a and 32b. For example, the optical path length may be increased ( or decreased) by stretching (or compressing) the fiber segment wound around the piezoelectric cylinder. The change in the optical path length corresponds to modulation of optical phase within the cavity 36 of the primary slave laser oscillator 14.

When the free running wavelength of the laser 14 (i.e., when the primary slave laser oscillator 14 is not locked to the master laser 12) is close to the wavelength of the master laser 12 to within the locking range of the feedback unit 34, the appropriate sign and magnitude of phase change is generated at the phase modulator 32 in order to match the wavelengths of the master laser 12 and slave laser 14.

In this embodiment, laser 14 includes a rare earth doped fiber 16 (active fiber) with optical power gain and the optical path length, n₂d₂, where n₂ is the effective refractive index of the optical fiber and d₂ is the physical length of the optical fiber. The optical path length of the active fiber is longer than the passive, non-guided-wave optical path length, Σn₁ᵢd₁ᵢ, within the laser cavity, where is n₁ᵢ are the refractive indices of optical media along the passive optical path, and d₁ᵢ are the corresponding distances or thickness of the media along this passive path. The optical path length Σn₁ᵢd₁ᵢ is kept as minimum as possible, and the total optical path length, L, (L=Σn₁ᵢd₁ᵢ+n₂d₂) of the laser cavity 36 of the laser system of 10 of this embodiment is chosen such that the free spectral range, f_{cav} of the laser cavity, (see FIG. 1b), can still be a least 5 MHz, corresponding to a total optical path length L of about 60 m. Further, in this embodiment, the optical path length L is chosen such that the free spectral range of the cavity 36, f_{cav}, is not equal to the modulation frequency, f_{mod}, of the electro-optic modulator 20. More specifically, in this embodiment said laser system further includes an EOM coupled to an EOM driver and said cavity has a cavity length L such that f_{mod}>f_{cav}, where f_{mod} is the frequency of the EOM driver and f_{cav} is the cavity spacing (i.e., the distance between the signal modes (w/o EOM present), as determined by the cavity length L of the primary slave laser oscillator. It is preferable that the length L is greater than 0.25 m, and preferably greater than 1 m.

The double clad construction of the Yb doped optical fiber 18 enables high optical power from the multimode output of a pump laser 38 (for example, a 980 nm pump) to be coupled into the inner cladding of the fiber 18. This coupling is facilitated by the pump-signal combiner 40. The pump light at 980 nm coupled into the inner cladding, for example, by virtue of overlapping wave-guidance to the Yb doped core of the fiber 18, and enables optical power gain for the light emission (in the range of 1020 nm to 1180 nm) in the Yb doped core. Other ways of pumping the laser fiber 18 may also be utilized, for example side pumping by utilizing V-grooves or prisms, and end-pumping by utilizing dichroic mirrors.

In this embodiment, the Yb doped fiber 18 serves a double role, both as an optical power gain medium, and as an optical phase element which can be modulated by the piezoelectric cylinders 32a and 32b.

Further, the smaller diameter of the fast piezoelectric cylinder 32a enables the phase modulator 32 to assume the additional role of (an optical) modal filter whenever the core of the Yb doped double clad fiber 18 supports higher order modes. The larger the core diameter of the rare earth doped fiber 18 the higher would be the end-face coupling efficiency of the fiber to the incident light. However, when the core diameter is large, for example, 15 μm or larger, higher order modes will be supported in the fiber core. Thus, coiling the fiber 18 onto the piezoelectric cylinders 32a and 32b for the purpose of phase modulation, also enables the radiation of the higher order modes out of the core of the fiber 18. The extent to which the higher order mode propagation within the fiber 18 is suppressed depends on the differential bending loss between the fundamental mode and the higher order modes. Thus in this embodiment, the optical phase modulator 32 also doubles in role as a beneficial modal filter.

Mode-matching optical components 42, for example microscope objectives and/or telescopes enable injection of the intracavity light into, and extraction of the light from, the Yb doped double clad fiber 18. Suitable polarization control optical elements 44 may be added optionally at the penalty of extra internal losses. The high optical power output (higher than 1 W and preferably higher than 10 W and preferably higher than 50 W) from the laser 14 is provided at the input-output coupler, which in this embodiment is mirror 46. In this embodiment, the highly reflecting mirror 48 reflects the light (in the counter-clockwise direction) towards the input-output coupler 46. In this embodiment the input/output coupler 46 is a partially reflective mirror. The optical transmission of the input-output coupler 46 is chosen, based on theoretical optical impedance matching principles, to match the internal losses of the laser cavity 36. For example, if the loss in the laser cavity 36 is 4%, the transmissivity of the input-output coupler (mirror) 46 should be 4%. The portion of the light coming from the mirror 48, and subsequently reflected by the input-output coupler 46 is coupled into the fiber 18 utilizing a mode-matching optics, for example, a microscope objective 42. A partial reflector 22 is utilized to divert a small portion, for example, 1% or 2%, of the light exiting the input-output coupler 46 to the photodetector 24.

As it is important to reduce the internal losses as much as possible, the reflection losses at the interfaces of the mode-matching optics 42 are minimized by utilizing anti-reflection coatings for the light wavelengths within the laser cavity 36.

Damage when focusing very high intracavity powers into the small diameter of the fiber core can also be minimized when the core diameter of the fiber 18 is large, greater than 10 μm, preferably greater than 15 μm core diameter and preferably having greater than 150 μm² modal area.

The introduction of a rare earth doped optical fiber 16 as a gain medium into the slave laser 14 alleviates the self-focusing and related thermal issues arising in solid state laser media of the non-fiber kind. The introduction of the rare earth doped fiber medium 16 (for example, the Yb doped fiber 18) also brings in the significant advantage of tunability of the injection-locked slave laser 14 when the master laser 12 is being tuned. Unlike fiber lasers, the solid state high power lasers of the non-fiber kind are limited in the wavelength tunability. It is also possible to passively injection lock a pulsed slave laser 14 to the master laser 12, thus improving its spectral fidelity.

Further, the rare-earth doped fiber 18 can also be of the polarization maintaining kind or the single polarization kind. The light polarization at the input-output coupler 46 and within the laser cavity 36 would be stable when a polarization maintaining fiber is utilized. Correspondingly, the light polarization at the input-output coupler 46 and within the laser cavity 36 would be linearly polarized when a single-polarization fiber is utilized. Such a single polarization rare earth doped fiber is disclosed, for example, in U.S. application number US-2005-0158006, filed on Jul. 21, 2005 in the names of Joohyun Koh; Christine Louise Tennent; Donnell Thaddeus Walton; Ji Wang and Luis Alberto Zenteno. Thus, one main advantage of the laser system 10 of this embodiment is that the fiber 18 in the slave laser 14 may assume one, or more, of several concurrent roles, namely, (i) optical gain medium, (ii) polarization maintaining wave guided path, (iii) polarizing wave guided path, (iv) optical phase modulator, and (v) optical birefringence modulator/controller (when coiled appropriately on paddles to form waveplates and is suitably rotated).

The main advantage of the injection-locking approach is that the spectral purity (single frequency operation) and stability of the low power master laser 12 are transferred with high fidelity to the high power slave laser 14 which would otherwise (for example, when unlocked from the master laser) have a very broad wavelength spectrum (for example, 20 nm) accompanied by instabilities associated with the highly multi-longitudinal mode nature of a long cavity (for example, a fiber length of 40 m). This injection-locking approach eliminates or minimizes the utilization of intracavity frequency-selective devices such as etalons and direction-selective devices such as isolators, all of which introduce high intracavity losses. Further, such devices are known to fail in performance or be damaged when very high intracavity optical powers (for example, hundreds of watts) circulate within the cavity 36. Unidirectional operation in the high power long cavity length slave laser 14 is achieved in the same direction as the master laser light coupled into the slave laser 14 by the input-output coupler 46, without the need for optical isolator.

Further, the incorporation of the fiber 16 as a gain medium results in a generically compact laser (with small footprint), by virtue of coiling a long fiber onto piezoelectric cylinders with small diameters (typically less than 3 inches).

Those skilled in the art will recognize that other locking techniques such as the Hansch-Couillaud technique, and the modulation-free interferometric tilt-locking scheme (to a lesser degree with added complexity), are also applicable here, with suitable modifications to the optical and electronic schematic shown in FIG. 1a.

Another embodiment of the present invention involves concurrent intracavity optical frequency conversion within a high power slave laser 14 while being injection-locked to a master laser 12 and generating light in the visible, ultraviolet and deep ultraviolet wavelengths or intermediate wavelengths thereof. This concurrent frequency conversion, and thereby, the generation of new wavelengths, is made possible by having the high intracavity optical powers at the near-IR wavelength, for example 1064 nm, accompanied by high spectral purity and stability when injection-locking is achieved.

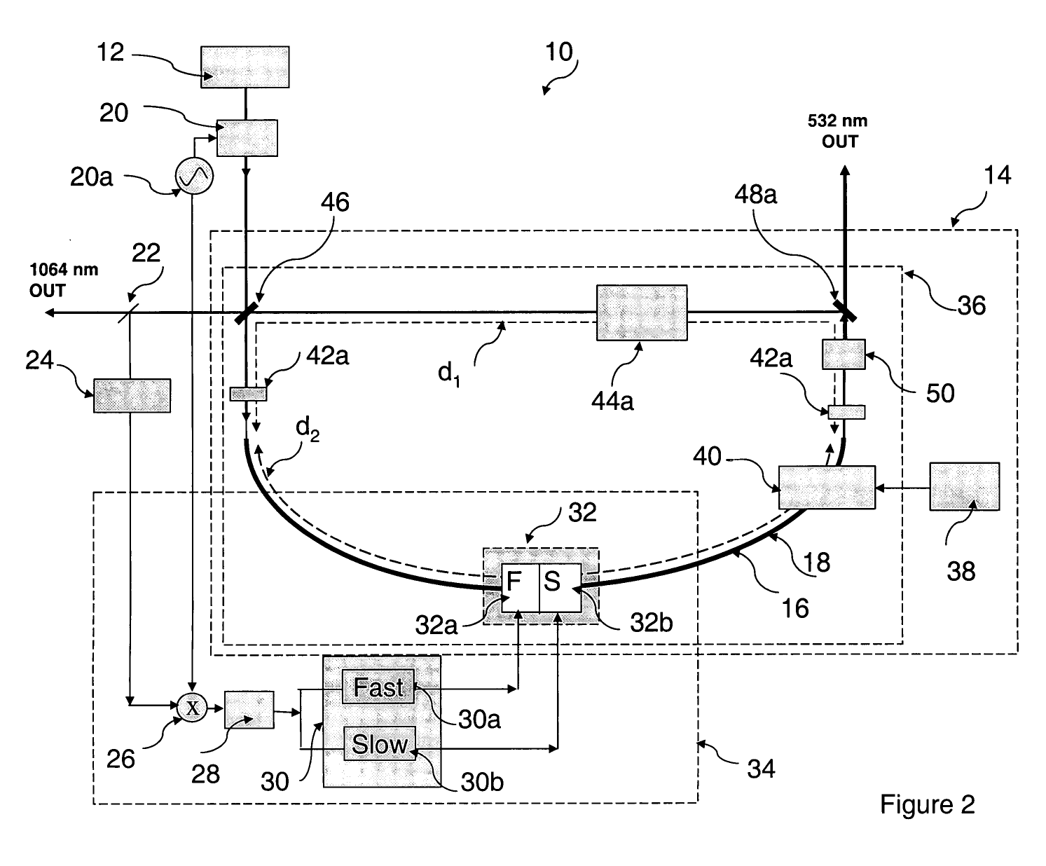

FIG. 2 illustrates the optical and electronic schematic of an exemplary laser system 10 comprising high power slave laser 14 injection-locked to the master laser 12. Concurrent frequency conversion is performed while the fundamental radiation re-circulating in the cavity 36 stays injection-locked to the master laser 12. As in the previous embodiment, the laser 14 includes, as an (active) optical gain medium, a length of rare earth doped fiber 16. The laser 14 of this embodiment is similar to that illustrated in FIG. 1a, but includes an additional optical frequency converter 50. The optical frequency converter 50 may include a crystal, for example, lithium triborate (LBO); potassium titanyl phosphate (KTP); periodically poled KTP (PPKTP); periodically poled lithium niobate (PPLN); magnesium oxide doped periodically poled lithium niobate (MgO:PPLN); magnesium oxide doped periodically poled stoichiometric lithium niobate (MgO:PPSLN); periodically poled lithium tantalate (PPLT); magnesium oxide doped periodically poled lithium tantalate (MgO:PPLT), or magnesium oxide doped periodically poled stoichiometric lithium tantalate (MgO:PPSLT) or other suitable crystals appropriately phase-matched. The periodically poled crystals may also incorporate waveguides, making longer interaction lengths possible. When optical radiation of wavelength λ enters such a second harmonic generator crystal, a portion of optical energy is converted to an optical signal with double the frequency and half the wavelength of the original signal wavelength λ. For example, if the signal optical signal of wavelength 1064 nm enters such crystal, a portion of the out-coming light provided by the frequency converter 50 will have a wavelength of 532 nm.

Alternatively, the frequency conversion process may be performed by utilizing the Raman effect. For example, a crystal such as barium tungstate (BaWO₄), can be used as a Raman converter, generating the first Stokes wavelength of 1180 nm from the fundamental wavelength of 1064 nm. In an extension of the same approach, the same crystal may be utilized to generate higher Stokes orders. Another extension of the same frequency conversion approach, involves the utilization of a Raman converter first, for example, Lithium iodate (LiO₃) crystal, to generate the first Stokes wavelength of 1156 nm, which subsequently is converted to the second harmonic wavelength of 578 nm by a lithium triborate crystal (LiB₃O₅).

In the generation of 532 nm output from the fundamental wavelength of 1064 nm, the mirror 48a of this embodiment transmits majority of the 532 nm light, thus providing a 532 nm laser output, and will reflect most of the 1064 nm light toward the mirror 46. As in the previous example, the transmission of the input-output coupler 46 is chosen, based on theoretical optical impedance matching principles, to match the combined internal losses of the laser cavity, which now includes the loss of the fundamental radiation due the frequency conversion process. For example, if the loss in the laser cavity is 5%, the transmissivity of the mirror 46 should be 5%.

The mode-matching optics 42a and 44a are now optimized to include the effects of the introduction of the frequency converter crystal 50. Typically, the optical birefringence introduced by the crystal would necessitate re-orientation of the polarization components within polarization control optical element 44a, while the need to focus the fundamental light into the crystal 50 would require transformation of the mode-matching characteristics to enable efficient light coupling into the fiber 18.

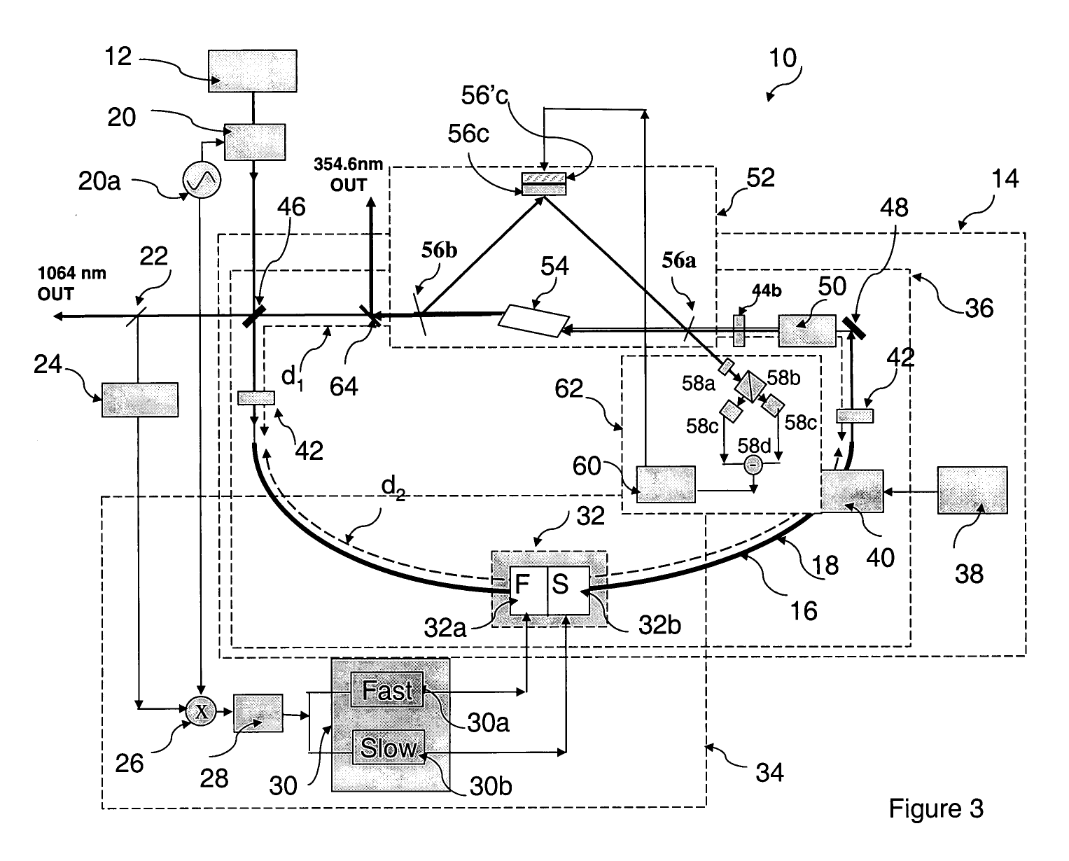

FIG. 3 illustrates the optical and electronic schematic of another exemplary laser system 10 comprising high power primary slave laser oscillator 14 injection-locked to the master laser 12. As in the previous embodiments, the laser 14 includes, as an active medium, a length of rare earth doped fiber 16. The laser 14 of this embodiment is similar to that illustrated in FIG. 2, but the optical frequency converter 50 is now located between mirrors 48 and 46, and is situated adjacent to the mirror 48. The exemplary laser system 10 includes an additional, secondary resonant cavity 52 associated with a secondary laser. The secondary resonant cavity 52 shares a common path with the primary cavity 36 of the laser 14, in order to extend the frequency conversion to the third harmonic wavelength, for example, 354.6 nm. Upon exiting the optical frequency converter 50, the light at the primary wavelength λ (for example, 1064 nm) as well as the light at the second harmonic (½λ, or, for example 532 nm) propagate towards the second frequency converter 54 (in this example, a third harmonic crystal generating 354.6 nm therefrom). In this embodiment the second frequency converter 54 is a lithium triborate (LBO) crystal.

In this embodiment, the secondary cavity 52 of the secondary laser or couplers also includes three mirrors 56a, 56b and 56c. The input-output coupler 56a is a partial reflector, with transmittance of about 1% to 10%, chosen to match the internal losses of the secondary cavity 52 at the second harmonic wavelength, here 532 nm. The input-output coupler 56a is also a dichroic mirror (wavelength separator) with high transmittance at 1064 nm. Mirror 56b is also a dichroic mirror which strongly transmits light at the wavelengths 1064 nm and 354.6 nm, and highly reflects light in the 532 nm wavelength. Upon impinging on mirror 56c, the 532 nm light is reflected towards mirror 56a. Thus, the 532 nm light is re-circulated in the secondary cavity 52. The mirror 56c is attached to the piezoelectric plate 56′c, and its position is modulated by an electrical signal supplied to the piezoelectric plate 56′c. The change in position of mirror 56 changes the cavity lengths of the secondary cavity 52.

The reflected light (at the second harmonic wavelength) at the mirror 56a and the leakage light (at the second harmonic wavelength, exiting the mirror 56a after a round trip through the cavity 52), interfere optically, and provide the input optical light for the Hansch-Couillaud servo assembly 62. More specifically, the Hansch-Couillaud servo assembly 62 includes a quarter wave plate 58a, a polarizing beam splitter 58b, two photodetectors 58c, an electronic subtractor 58d and feedback circuitry including an integrator 60 form the Hansch-Couillaud servo assembly 62. The integrated error signal from the servo assembly 62 is fed into the piezoelectric plate 56′c.

The 532 nm beam is resonated within the secondary cavity 52, when the Hansch-Couillaud servo assembly holds the cavity 52 in resonance with the input radiation at 532 nm coming from the second harmonic crystal 50. The 1064 nm light within the primary cavity 36 (i.e. the cavity of the primary slave laser oscillator) and the 532 nm light resonated within secondary cavity 52 are mixed in the crystal 54, which is phase-matched to perform sum frequency generation of 354.5 nm from 1064 nm and 532 nm light. A dichroic mirror (harmonic separator) 64 separates the 354.6 nm light from the 1064 nm beam of the primary cavity 36 and the residual 532 nm light leaking out of the mirror 56b of the secondary cavity 52. The 1064 nm beam transmitted through the dichroic mirror 64 travels towards mirror 46 which directs the 1064 nm beam towards the mode-matching optics 42 and the rare-earth doped fiber 18.

At least one optical component of this secondary cavity, for example one mirror 56c does not share the common path with the primary cavity. Thus atleast one segment of the secondary cavity is not situated within the primary cavity (i.e it is not within the cavity of the primary slave laser oscillator). In this example, mirror 56c is suitably bonded to an actuator 56′c, for example, of the piezoelectric kind, and is movable.

The secondary cavity 52 can be, for example, a closed triangular cavity, as shown in FIG. 3, or a bow-tie cavity (not shown), both types supporting unidirectional propagation, but not supporting bidirectional operation as in a linear or folded-L or V type cavity (not shown).

It is pointed out that the sharing of a common intracavity path of the secondary cavity with the primary cavity (i.e. the cavity of the primary slave laser oscillator 14) results in a very compact laser system with a reduced footprint. For certain applications, wherein a non-overlapping primary and secondary cavity becomes necessary or wherein compactness is of lesser importance, the same underlying optical operation based on injection locked intracavity harmonic generation can also be utilized and is equivalent to the embodiment of FIG. 3.

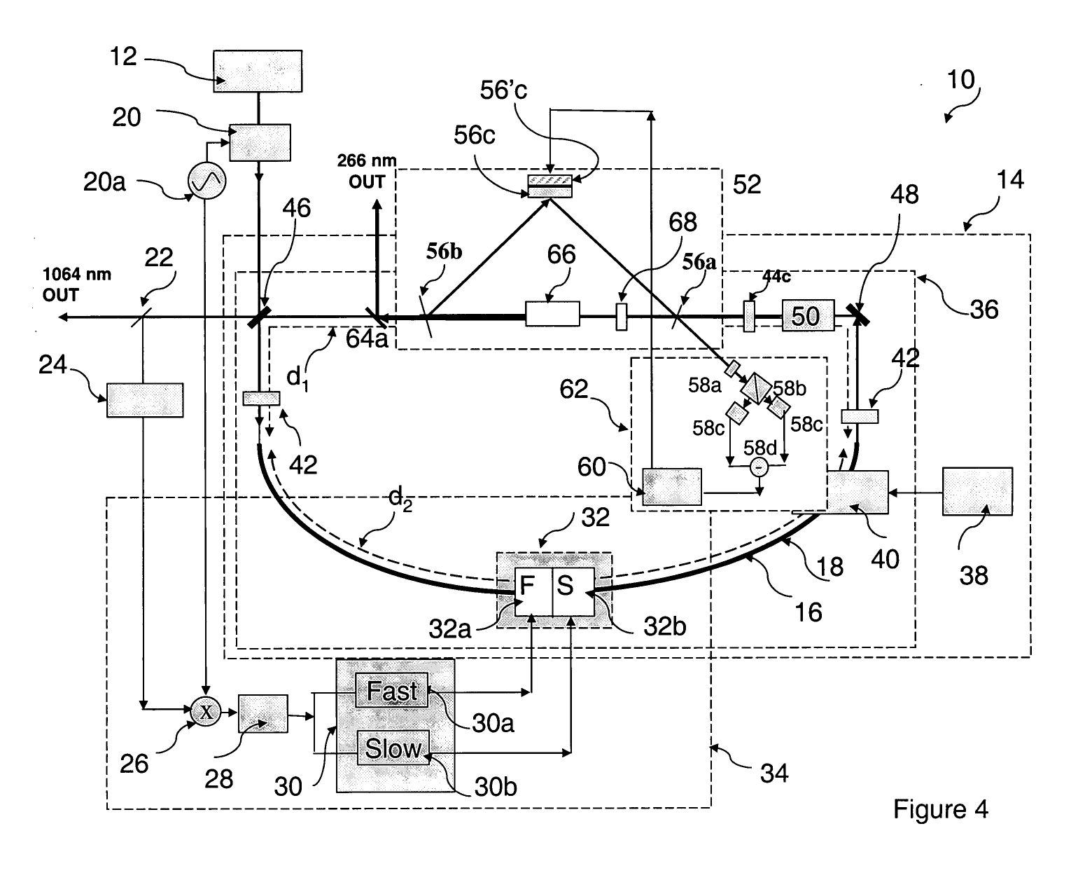

FIG. 4 illustrates the optical and electronic schematic of another exemplary laser system 10 comprising high power slave laser 14 injection-locked to the master laser 12. As in the previous embodiments, the laser 14 includes, as an active medium, a length of rare earth doped fiber 16. The laser 14 of this embodiment is similar to that illustrated in FIG. 3, but the third harmonic generator (crystal 54) is replaced with a fourth harmonic generator (crystal 66). Instead of utilizing anti-reflection coatings on the frequency converter (crystal 66), and the polarizer 68, as shown in FIG. 4, the crystal 66 may be cut at Brewster angle, and aligned in a manner similar to the crystal 54 shown in FIG. 3. The Hansch-Couillaud servo assembly 62 described earlier in the description of FIG. 3 for third harmonic generation applies identically to FIG. 4 for fourth harmonic generation. The crystal 66 (fourth harmonic generator) is phase matched to convert the incident second harmonic light, for example, green light at 532 nm into the fourth harmonic at 266 nm. The generated 266 nm light is then separated from the intracavity 1064 nm light in the primary cavity 36 and the 532 nm light resonating in the secondary cavity 52.

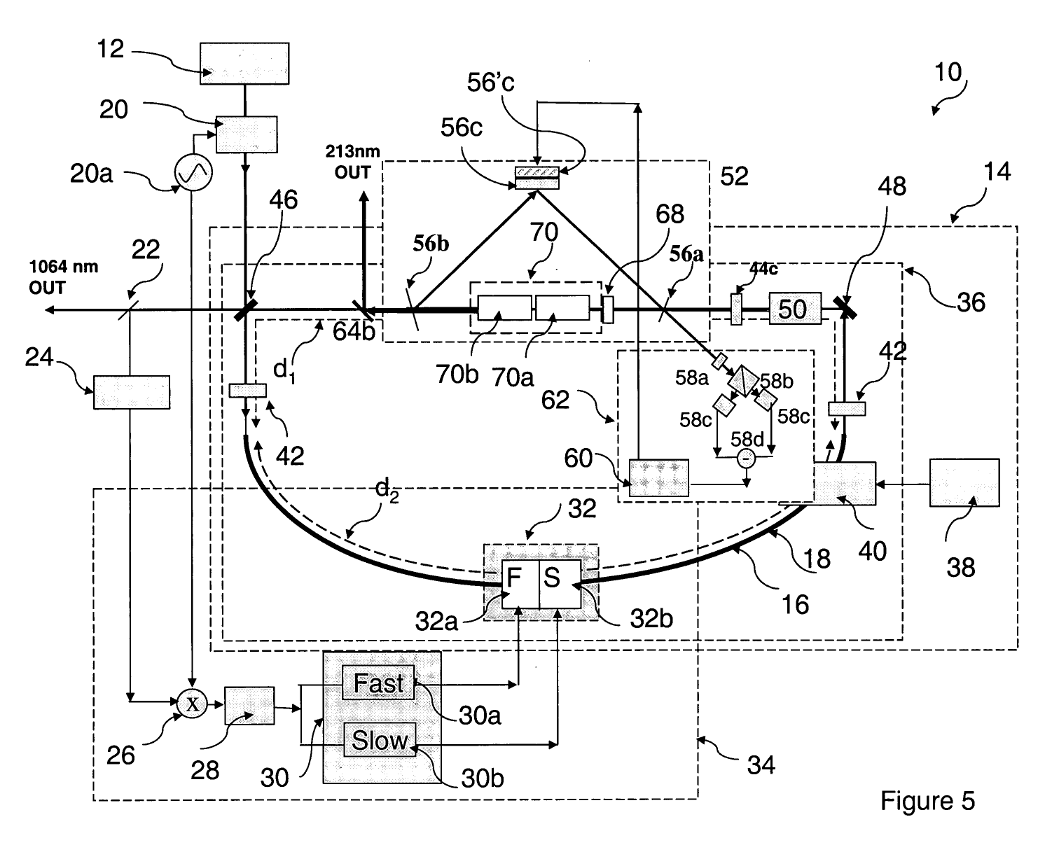

FIG. 5 illustrates the optical and electronic schematic of another exemplary laser system 10 comprising high power slave laser 14 injection-locked to the master laser 12. As in the previous embodiments, the laser 14 includes, as an (active) optical power gain medium, a length of rare earth doped fiber 16. The laser 14 of this embodiment is similar to that illustrated in FIGS. 3 and 4, but the secondary cavity 52 now includes an additional (3^{rd}) optical frequency converter 70b which is located adjacent to the (2^{nd}) frequency converter 70a. Thus, the laser system shown in FIG. 5 delivers light at the fifth harmonic frequency, starting from the high power fundamental light injection-locked to the master laser 12. More specifically, laser system 10 of this exemplary embodiment generates laser radiation at the fifth harmonic, 213 nm, of the fundamental IR light at 1064 nm, via another nonlinear crystal 70b suitably placed within the secondary cavity 52 following the first nonlinear crystal 70a (within the secondary cavity) that generates either the third harmonic or the fourth harmonic. When the crystal 70a is phase matched for generating the third harmonic of the fundamental light 1064 nm resonating in the primary cavity 36, the crystal 70b is phase-matched to generate the fifth harmonic from the sum frequency generation of the 2^{nd} harmonic 532 nm light resonating in the secondary cavity 52 and the third harmonic generated by crystal 70a. When the crystal 70a is phase matched for generating the fourth harmonic of the fundamental light 1064 nm resonating in the primary cavity 36, the crystal 70b is phase-matched to generate the fifth harmonic from the sum frequency generation of the fundamental light at 1064 nm resonating in the primary cavity 36 and the fourth harmonic generated by crystal 70a.

An interesting feature of this configuration is that the spectral width of the fifth harmonic light can be changed from a single frequency to a multi-axial-mode operation by changing the length L′ of the secondary cavity 52 relative to the length L of the primary cavity 36. For example, a longer secondary cavity 52 may support more than one axial mode, all such axial modes falling within the line-width of the single frequency light of the primary cavity 36.

The laser systems shown in FIGS. 3, 4 and 5 are embodiments of very compact laser systems because in each case the secondary cavity 52 shares a substantial portion of its cavity with that of the primary cavity 36.

Alternatively, the laser system 10, shown for example in FIG. 5, instead of using birefringently phase-matched harmonic generation as done with one crystal (54 in FIG. 3 or 66 in FIG. 4) or two optical crystals (70a and 70b in FIG. 5), may utilize a self-phase matched Raman frequency shift in a crystal to produce an optical beam of the desired wavelength. A very novel laser system results when the first nonlinear medium within the secondary laser cavity generates Raman-shifted frequency from either (a) the intracavity 1064 nm light resonating in the primary cavity 36, and (b) the intracavity 532 nm light resonating in the secondary cavity 52, or (c) both the intracavity beams at 1064 nm and 532 nm as described in (a) and (b) above. This Raman-shifted frequency approach allows access to a wide range of frequencies (and thus optical wavelengths). The Raman-shifted light can then be resonated within the secondary cavity 52 when mirrors 56a, 56b, and 56c are chosen with appropriate coatings to re-circulate (a) the Raman shifted wavelength from the fundamental 1064 nm light, (b) the second harmonic 532 nm light along with the Raman-shifted light both from the 1064 nm and 532 nm wavelengths. The Raman shifted light is then separated from the 1064 nm light and the residual 532 nm light by an appropriate dichroic mirror 64b.

The second crystal 70b in the secondary cavity 52 of FIG. 5 can be phase matched to mix any of the Raman-shifted light generated by the first crystal 70a of the secondary cavity 52, with either the fundamental light at 1064 nm or the second harmonic light at 532 nm.

The same photo-detection circuitry and electronic schematic for the servo assembly as shown in FIGS. 3, 4 and 5 is applicable here for the generation of the Raman-shifted light or its mixing with the 1064 nm and/or the 532 nm light.

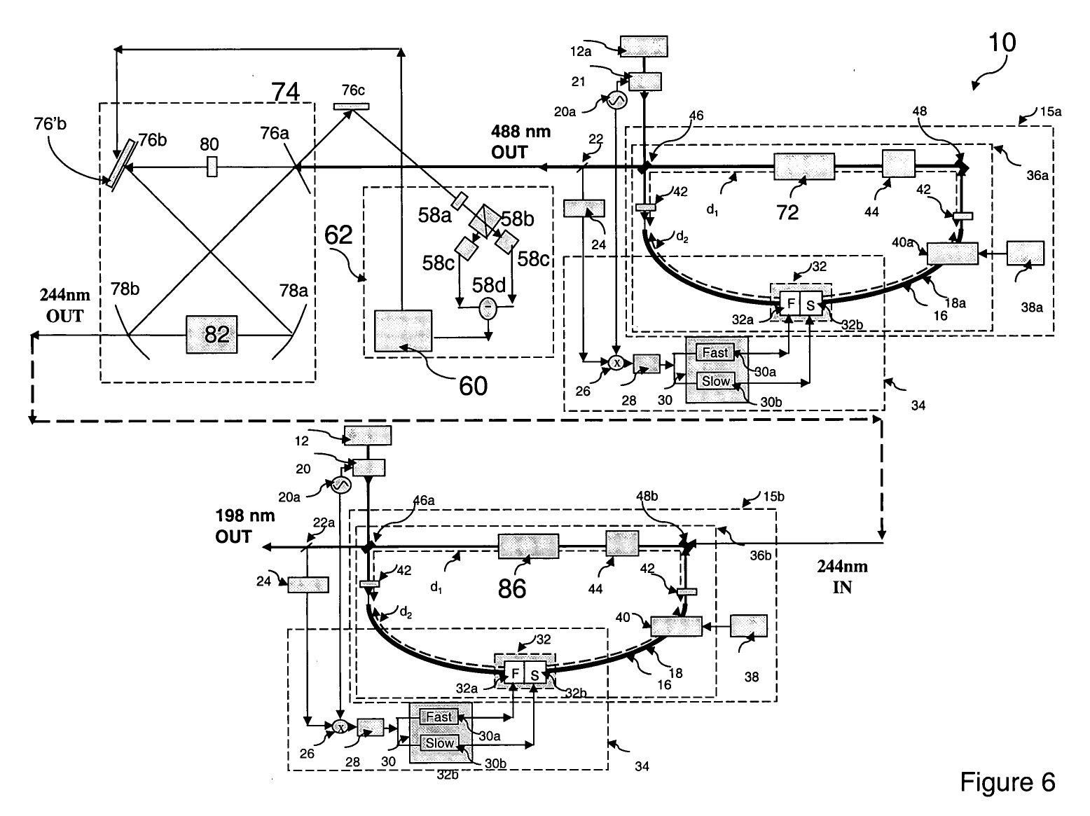

FIG. 6 illustrates a laser system 10 that utilizes the combined operation of two individually injection-locked primary laser oscillators 15a and 15b. The two primary laser oscillator 15a and 15b have two different starting fundamental wavelengths, for example, 976 nm and 1064 nm respectively. Further, an external resonant cavity 74, without any optical gain medium in it, is placed between the two primary cavities 15a and 15b in order to generate the fourth harmonic 244 nm light of the primary laser oscillator 15a resonating at 976 nm. This combined system is described in further detail below.

The primary laser oscillator 15a generates an optical output at 488 nm, the second harmonic of the resonant fundamental light at 976 nm within the primary cavity 36a. The crystal 72 then converts the 976 nm light into 488 nm light. The master laser 12a (i.e. the master laser) operates at the wavelength of 976 nm, and the pump laser 38a operates at a wavelength of 915 nm. The pump combiner 40 combines the pump light at the wavelength of 915 nm and the resonant wavelength of 976 nm. The primary cavity 15a is injection-locked to the master laser 12a utilizing an electro-optic modulator 21, PDH servo integrator circuitry 34 and the phase modulator 32, as described earlier.

The 488 nm output of the primary laser oscillator 15a is incident on an external resonant cavity 74, within which a second harmonic generator crystal 82 is placed. The crystal 82 converts the resonant intracavity 488 nm light into 244 nm. The 244 nm light output is then separated by the dichroic curved mirror 78b from the resonant 488 nm light within the cavity 74. The cavity 74 is held in resonance to the incoming 488 nm light utilizing the Hansch-Couillaud servo assembly 62 as described earlier. The feedback signal from the servo assembly 62 is fed to the piezoelectric actuator 76′b attached to the mirror 76b. An optional polarizer 80 may be added within the cavity for the operation of the Hansch-Couillaud polarization analysis.

The 244 nm light output from the cavity 74 is then injected into the cavity 36b of the primary laser oscillator 15b through the dichroic mirror 48b. The cavity 36b is resonant at 1064 nm, which wavelength is incident on the crystal 86 along with the incoming 244 nm light 84. The crystal 86 mixes the two wavelengths of 1064 nm and 244 nm to generate 198 nm light. The 244 nm light is not resonated within the primary cavity 36b. The primary cavity 36b is held in resonance to the master laser 12 operating at 1064 nm by utilizing the PDH technique of injection locking as described above. The dichoric mirrors 48b and 46a are high reflectors at 1064 nm and transparent at 244 nm and 198 nm. The dichroic mirror 22a separates the 198 nm light from the residual light at 1064 nm or 244 nm.

One very significant advantage of the embodiment of the present invention, as described above and as shown schematically in FIG. 6, is that it results in substantial reduction of the optical damage to the nonlinear optical frequency converter crystal. This advantage is achieved by increasing the intracavity infrared power, for example at 1064 nm, and concurrently and correspondingly reducing the input/internal ultraviolet power, for example, at 244 nm, thereby preserving the output deep ultraviolet power level, for example, at 198 nm. For example, increasing the IR power by a factor of two while decreasing the UV power by the factor of two provides the same amount of output power at 198 nm wavelengths, but avoids damage to the CLBO crystal 86. This concept takes advantage of the linear dependence of the power at the deep-ultraviolet wavelength on the power at the ultraviolet wavelength, when the infrared power far exceeds the ultraviolet power, as well as known mechanisms of damage in the crystal 86. In our example, the preferable range of intracavity (cavity 36b of the primary slave laser oscillator 15b in FIG. 6) infra red IR light (for example, wavelength of 1064 nm) power is larger than 500 W and the preferable range of UV light (for example, wavelength of about 244 nm) power is less than 600 mW. It is even more preferable that the range of intracavity IR (wavelength of 1064 nm) power is larger than 1000 W and the preferable range of UV power is less than 300 mW. It is most preferable that the range of intracavity IR power is larger than 2000 W and the preferable range of UV power is less than 150 mW.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

We claim:

1. A high power laser system comprising:
(I) a master laser;
(II) a primary slave laser oscillator including a cavity comprising a rare earth doped fiber, said primary slave laser oscillator being actively injection-locked to said master laser, wherein said cavity provides an output exceeding 1 W of optical power.

2. The high power laser system according to claim 1 wherein the active optical path length within the earth doped fiber is longer than the passive optical path length within the primary slave laser oscillator.

3. A high power laser system according to claim 1, wherein said cavity of said primary slave laser oscillator includes a phase modulator that is capable of modulating the optical phase within at least a portion of said earth doped fiber to lock the optical signal frequency, and the phase modulator functions as a modal filter.

4. A high power laser system according to claim 1 wherein said rare earth doped fiber is a polarization maintaining fiber.

5. The laser system of claim 4 wherein said rare-earth doped fiber is a single polarization fiber.

6. The laser system of claim 1 wherein said cavity of said primary slave laser oscillator includes a second harmonic generator.

7. The laser system of claim 1 wherein said laser system includes a secondary cavity and said secondary cavity includes a third harmonic generator.

8. The laser system of claim 1 wherein said laser system includes a secondary cavity and said secondary cavity includes a fourth harmonic generator.

9. The laser system of claim 1 wherein said laser system includes a secondary cavity and said secondary cavity includes a fifth harmonic generator.

10. The laser system of claim 6, wherein said laser system includes a secondary cavity and said secondary cavity includes a Raman converter crystal.

11. The laser system of claim 6, wherein said laser system includes a secondary cavity, and wherein said cavity of said primary slave laser oscillator and said secondary cavity share at least one common optical component; and at least one segment of said secondary cavity is not within said cavity of the primary slave laser oscillator.

12. The laser system of claim 11, wherein said common component is a frequency converter crystal.

13. The laser system of claim 1 wherein said laser system further includes an electro optic modulator coupled to an electro optic modulator driver and said cavity has a cavity length L such that f_{mod}<f_{cav}, where f_{mod} is the frequency of the EOM driver and f_{cav} is the cavity spacing, as determined by the cavity length L, and L is greater than 0.25 m.

14. The laser system of claim 1 wherein said cavity does not include a linear polarizer operating in conjunction with said fiber.

15. The high power laser system according to claim 2, wherein said cavity of the primary slave laser oscillator includes a phase modulator that is capable of stretching at least a portion of said earth doped fiber to lock the optical signal frequency.

16. The high power laser system according to claim 15, wherein and the phase modulator functions as a modal filter.

17. The laser system of claim 1, wherein said cavity of said the primary slave laser oscillator includes a second harmonic generator.

18. The laser system of claim 4 wherein said laser system includes a secondary cavity and said secondary cavity includes a higher order harmonic generator, and said higher order harmonic generator is a third, fourth or fifth harmonic generator.

19. A high power laser system according to claim 2 wherein said rare earth doped fiber is a polarization maintaining fiber.

20. The laser system of claim 2 wherein said fiber is a single polarization fiber.

21. The high power laser system of claim 1 further comprising an additional primary slave laser oscillator, and said additional primary slave laser oscillator is injection locked to an additional master laser.

22. The high power laser system of claim 21 further including an intermediary external resonant cavity which is operationally connected to both primary slave laser oscillators.
